(19) United States
(12) Patent Application Publication
(10) Pub. No.: US 2020/0342040 A1
(43) Pub. Date: Oct. 29, 2020

(54) ONBOARD ENTERTAINMENT SYSTEMS AND METHODS

(71) Applicant: Global Onboard Partners, LLC, Atlanta, GA (US)

(72) Inventors: Kirk Adams, Atlanta, GA (US); Ben Fuller, Atlanta, GA (US)

(73) Assignee: Global Onboard Partners, LLC, Atlanta, GA (US)

(21) Appl. No.: 16/837,898

(22) Filed: Apr. 1, 2020

Related U.S. Application Data
(60) Provisional application No. 62/827,620, filed on Apr. 1, 2019.

(51) Int. Cl. G06F 16/9535; G06F 3/0482; G06Q 30/02; G06Q 10/02; B64D 11/00

(52) U.S. Cl. CPC G06F 16/9535; G06F 3/0482; B64D 11/0015; G06Q 10/02; G06Q 30/0233

(57) ABSTRACT

Onboard entertainment platforms to be deployed on a common carrier such as an airplane, train, bus, or ship. A method includes determining a travel destination for a user and determining historical engagement data for the user engaging with an interactive entertainment platform. The method includes ranking a plurality of object categories within the interactive entertainment platform based on the current travel destination and the historical engagement data. The method includes receiving an indication that the user has selected an object category within the interactive entertainment platform.

### CROSS-REFERENCE TO RELATED APPLICATION

This application claims the benefit of U.S. Provisional Patent Application No. 62/827,620, filed Apr. 1, 2019, titled “ONBOARD ENTERTAINMENT SYSTEMS AND METHODS,” which is incorporated herein by reference in its entirety, including but not limited to those portions that specifically appear hereinafter, the incorporation by reference being made with the following exception: In the event that any portion of the above-referenced provisional application is inconsistent with this application, this application supersedes the above-referenced provisional application.

### TECHNICAL FIELD

The present disclosure relates to entertainment systems and particularly relates to onboard entertainment systems in transportation carriers.

### BACKGROUND

Entertainment systems on common carriers such as airplanes, trains, ships, and busses have experienced numerous improvements over time. Such entertainment systems may broadly be referred to as “onboard entertainment.” Onboard entertainment systems historically included one or more screens installed in the common carrier such that multiple people could watch a single screen. Movies, television shows, information programs, and so forth could be displayed on a screen such as a television or monitor. The entertainment program could be delivered to the screen by way of a separate storage device such as a tape, a digital video disc (DVD), a hard drive, and so forth. However, such entertainment systems are highly limited and may not be desirable for many passengers or common carrier providers. Group entertainment systems where multiple people may watch a single screen require the common carrier to select entertainment programming to be viewed by multiple people who have different tastes and preferences. Additionally, all people who wish to watch the entertainment program must watch the program at the same time and do not have flexibility in how or when the entertainment program is played.

Individual entertainment systems have been installed and some common carriers and especially on commercial aircraft. Some airplanes include an individual screen for each passenger such that the passenger may select personalized programming that may be watched at any time. In some instances, a touchscreen is installed in the back of the headrest on each seat on the airplane such that a passenger sitting behind a seat can watch personalized programming with the touchscreen. In some instances, the passenger may select from a database of available programming options and may watch the programming at any time. In some instances, the passenger may pay an additional fee to have access to the entertainment system, to watch programming on the entertainment system, and/or to play games on the entertainment system.

However, such individual entertainment systems are very expensive and can be prohibitively costly for some common carriers and/or passengers. An in-flight entertainment system for an aircraft carrier can constitute a substantial portion of the total cost of the aircraft. Additionally, entertainment systems are continually updated, and the installed in-flight entertainment system may become obsolete or out-of-date long before the aircraft carrier itself needs to be replaced. Additionally, such in-flight entertainment systems can be costly to maintain and may require monthly software fees, maintenance fees, and/or subscription fees that can be a significant financial burden for an airline. Because in-flight entertainment systems are costly and difficult to use, many airlines seek to find new means to provide in-flight entertainment and new means to generate revenue through in-flight entertainment. A similar trend is present in other common carrier industries including trains, buses, and ships.

In an effort to reduce the cost associated with individual entertainment systems that are installed in transportation vessel, some onboard entertainment systems are now Bring Your Own Device (BYOD). In the case of BYOD entertainment systems, entertainment media is transmitted to each passenger's personal device such as a smart phone, a computer, a tablet, and so forth. BYOD entertainment systems can be embedded into the transportation vessel such that the device is wired into the entertainment system for the transportation vessel. Further, BYOD entertainment systems can transmit entertainment media to passengers by way of intra vessel WiFi streaming or by way of an onboard entertainment server. The onboard entertainment server may be stored onsite on the transportation vessel but does not need to be wired into the transportation vessel. However, many portable Inflight Entertainment systems must run on batteries and have limitations with the resources that may be available on the transportation vessel.

In light of the foregoing, disclosed herein are systems, methods, and devices for improved onboard entertainment systems that can be applied to all transportation industries.

### BRIEF DESCRIPTION OF THE DRAWINGS

Non-limiting and non-exhaustive implementations of the present disclosure are described with reference to the following figures, wherein like reference numerals refer to like or similar parts throughout the various views unless otherwise specified. Advantages of the present disclosure will become better understood with regard to the following description and accompanying drawings where:

FIG. 1 is a schematic diagram of an onboard entertainment system, according to one embodiment;

FIG. 2 is a block diagram of an example entertainment platform, according to one embodiment;

FIG. 3 is a schematic diagram of a system of connecting a personal device to an onboard interface server by way of a scannable code, according to one embodiment;

FIG. 4 is a schematic block diagram of a process flow for providing information suggestions to a user of an entertainment platform, according to one embodiment;

FIG. 5 is a schematic block diagram of a process flow calculating a number and location of reward icons displayed in an entertainment platform, according to one embodiment;

FIG. 6 is a block diagram of an information organizational structure, according to one embodiment;

FIG. 7 is a schematic block diagram of a process flow ranking objects in an interactive information platform, according to one embodiment;

FIG. 8 is an example screenshot of an onboard information center, according to one embodiment;

FIG. 9 is an example screenshot of a selection page for tier one objects accessible in an onboard information center, according to one embodiment;

FIG. 10 is an example screenshot of a page for a tier one object in an onboard information center, according to one embodiment;

FIG. 11 is an example screenshot of an information page in an onboard information center, according to one embodiment; and

FIG. 12 is a schematic block diagram of an example computing system according to an example embodiment of the systems and methods described herein.

### DETAILED DESCRIPTION

Disclosed herein are systems, methods, and devices for improved entertainment systems that may be implemented in all transportation industries, including in aircraft, trains, busses, ships, and so forth. In many group transportation scenarios, and particularly on airplanes or ships where passengers do not have easy access to a network connection, it is desirable to provide entertainment options to all passengers. Some transportation carriers such as airplanes or cruise ships provide onboard entertainment that can be accessed by passengers so that passengers may select programming, games, informational material, and so forth to be viewed at any time during transit. However, such onboard entertainment systems can be prohibitively expensive for the transportation carrier and/or the passengers. Described herein are systems, methods, and devices for lower cost onboard entertainment systems and for generating revenue through onboard entertainment systems.

Embodiments of the systems, methods, and devices disclosed herein provides means for generating revenue through onboard entertainment. The profit margins for largescale transportation, and particularly for the airline industry or the cruise ship industry, can be small so that transportation providers are continually seeking means to cut costs without sacrificing passenger experience. Some transportation providers have attempted to generate revenue through onboard entertainment by displaying banner advertisements or pre-roll video advertisements through the onboard entertainment system. These advertisements can generate ancillary revenue for the transportation provider and may help reduce tickets costs for passengers who elect to view the advertisements and/or for all passengers. However, such advertisements are undesirable because they degrade the passenger experience and can be irritating to many passengers. Numerous transportation providers that have used banner advertisements and/or pre-roll video advertisements have received complaints from passengers that such advertisements are frustrating and annoying and often directed to goods or services that the passenger does not have an interest in purchasing. Additionally, advertisers are relucted to purchase space in banner advertisements and/or pre-roll video advertisements because those advertising spaces are frustrating for many customers and there is no guarantee that a passenger is even interested in the goods or services being advertised. Many transportation providers have sought alternative means to generate ancillary revenue through onboard entertainment without sacrificing passenger experience.

Additionally, embodiments of the systems, methods, and devices disclosed herein provide means for engaging passengers with onboard entertainment and retaining the passenger's engagement. Passenger engagement with onboard entertainment is low in some industries and can be difficult to maintain, particularly when the passenger is inundated with advertisements or other opportunities for the transportation provider to generate ancillary revenue. It is desirable to engage passengers with onboard entertainment and retains passengers' engagement with onboard entertainment so that ancillary revenue can be generated for the transportation provider.

An embodiment of the disclosure provides a means for a user to connect a personal device directly to an onboard entertainment platform by way of an onboard interface server. A scannable code is provided, and an image sensor associated with the user's personal device scans the code. The code includes instructions that may be executed by a processor of the user's personal device. The instructions may cause the personal device to connect directly to a network on a transportation vessel such as an airplane, a ship, a train, a bus, and so forth. In an embodiment, the instructions cause the personal device to connect to onboard Wi-Fi and connect the personal device with the onboard interface server.

Before the methods, systems, and devices for onboard entertainment systems are disclosed and described, it is to be understood that this disclosure is not limited to the configurations, process steps, and materials disclosed herein as such configurations, process steps, and materials may vary somewhat. It is also to be understood that the terminology employed herein is used for describing implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

A detailed description of systems, methods, and devices consistent with embodiments of the present disclosure is provided below. While several embodiments are described, it should be understood that this disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments may be practiced without some or all of these details. Moreover, for clarity, certain technical material that is known in the related art has not been described in detail to avoid unnecessarily obscuring the disclosure.

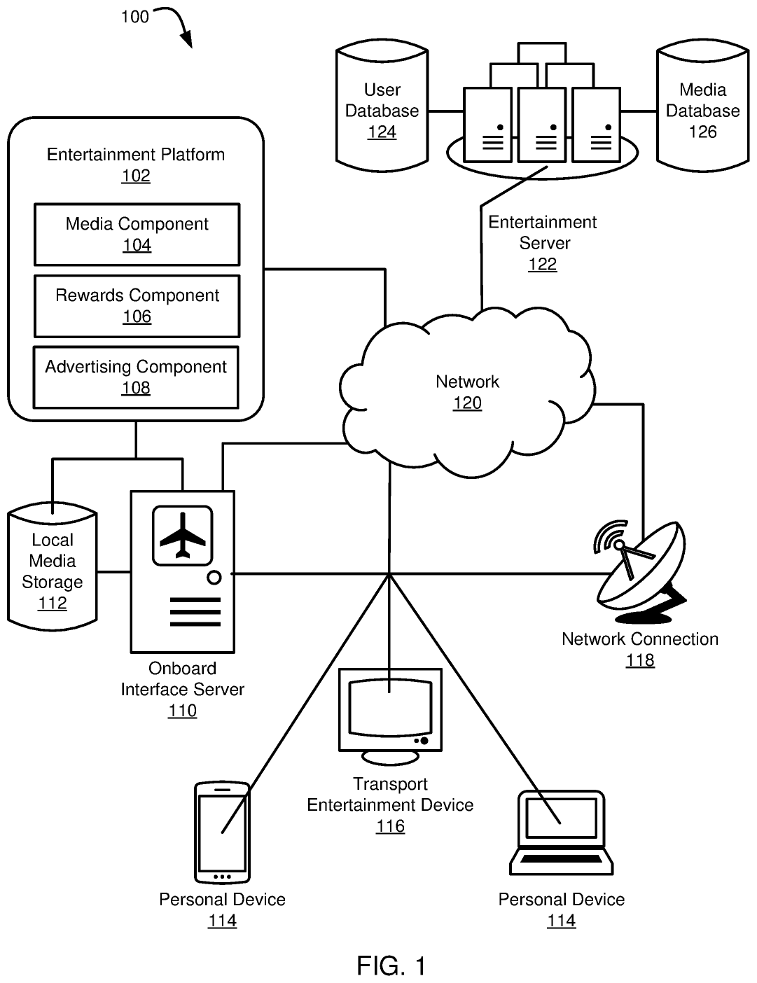

Referring now to the figures, FIG. 1 is a schematic diagram of a system 100 for onboard entertainment. The system 100 may be applied in any means for transportation, including for example, an aircraft, a train, a bus, a boat or ship, and so forth. The system 100 includes an entertainment platform 102 in communication with an onboard interface server 110 and a network 120. The network 120 is in communication with the onboard interface server 110 and an entertainment server 122. Onboard access to the network 120 may be provided during transit by way of a network connection 118 that may be connected with the onboard interface server and/or individual devices such as a transport entertainment device 116 and/or a personal device 114.

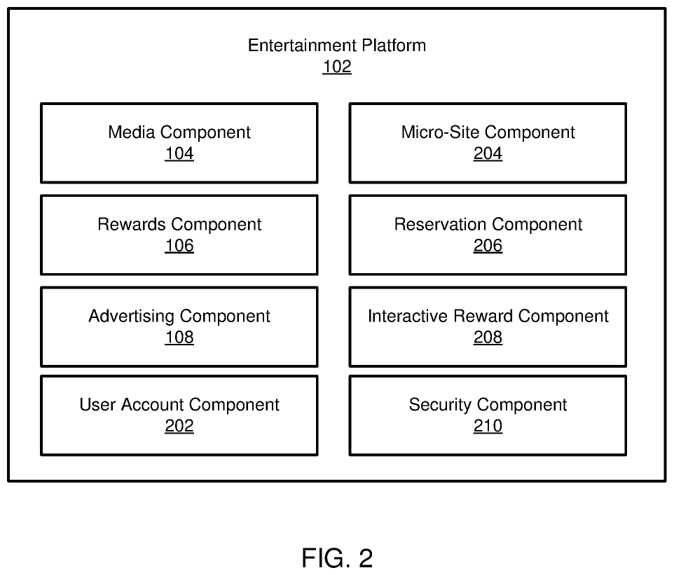

The entertainment platform 102 includes one or more of a media component 104, a rewards component 106, and an advertising component 108. The entertainment platform 102 may include further components and may be configured to perform additional instructions, for example according to the entertainment platform 102 as discussed in FIG. 2. The entertainment platform 102 can be accessed by way of a transport entertainment device 116 that may be integrated or permanently fixed in a transport vessel. The entertainment platform 102 may further be accessed by way of a personal device 114 such as a smart phone, a tablet, a laptop, a personal computer, and so forth.

The media component 104 of the entertainment platform 102 provides access to media content such as movies, television programs, informational programs, games, interactive information stores, and so forth. The media component 104 provides a user the ability to select certain media content and interact with the desired media content.

The rewards component 106 of the entertainment platform 102 provides access to user rewards. The user rewards may be granted to a user as the user engages with the entertainment platform 102. In an embodiment, the rewards component 106 integrates interactive rewards throughout the entertainment platform 102 and grants credits to a user account when a user selects or otherwise interacts with the interactive rewards. In an embodiment, the interactive rewards include animations, virtual stickers, buttons, rankings, or banners that are integrated on different pages throughout the entertainment platform 102. The rewards component 106 may determine how many interactive rewards are available to a user and may further determine where those interactive rewards are visible to the user throughout the entertainment platform 102. The rewards component 106 may create an account for a user such that the user's reward history can be stored in the user database 124 and made accessible to the entertainment platform by way of the network 120. In the account, the user may provide personal information, travel history information, travel wish list information, current travel information, advertising preferences, reward preferences, interests, and so forth.

In an embodiment, the rewards component 106 determines a “leaderboard” style reward based on competition between users of the system 100. In an embodiment, the leaderboard reward system enables managers to oversee crewmembers' participation along with passengers' participation. In an embodiment, users accessing the system 100 includes passengers, crewmembers, managers, and account administrators.

The advertising component 108 of the entertainment platform 102 provides access to advertising programs. In an embodiment, the advertising component 108 provides access to an advertising account for generating or uploading advertisements or other content to be displayed on the entertainment platform. The advertising account may be accessed by a party interested in advertising on the entertainment platform such as a marketing firm or a business seeking to display advertisements or informational content on the entertainment platform 102. The advertising component 108 may use personal information stored in a user account to tailor advertisements or information to a certain user to increase the chance the user will be interested in the content of the advertisements.

The onboard interface server 110 provides access to the entertainment platform 102 to transport entertainment devices 116 and/or personal devices 114 onboard the transportation vessel. The onboard interface server 110 serves as a local entertainment server on board the transportation vessel such as the airplane, ship, train, or bus. In an implementation, the onboard interface server 110 is on an aircraft and may be referred to as the main aircraft interface server or the in-flight entertainment server. In an embodiment, the onboard interface server 110 is essentially a small computer that controls the entire onboard entertainment system. The onboard interface server 110 may be connected to one or more local media storage 112 devices in a local area network (LAN). In an embodiment, ethernet internet protocol (IP) addresses are used across the transportation vessel to enable the onboard interface server 110 to communicate with other devices. The onboard interface server 110 may serve as a central dedicated computer to support the entertainment platform 102 for all devices (see 116, 114) on the transportation vessel.

In an embodiment the onboard interface server 110 is a line-replaceable unit (LRU). A line-replaceable unit is a modular component that is designed to be replaced quickly at an operating location. Line-replaceable units may be commonly used in transportation vessels such as airplanes, ships, or spacecraft because they can quickly be removed and installed to be replaced or updated. When the onboard interface server 110 is implemented as a line-replaceable unit, the onboard interface server 110 may easily be removed from the transportation vessel and updated with new software, firmware, or data. In an embodiment, the media content of the entertainment platform 102 is stored on the onboard interface server 110 and the onboard interface server 110 is removed from the transportation vessel each time new media content is uploaded or stored to the onboard interface server 110.

The local media storage 112 in communication with the onboard interface server 110. In an embodiment, the media content for the entertainment platform 102 is stored locally on the local media storage 112. The local media storage 112 may be implemented as a line-replaceable unit such that the unit may be removed each time new media content is added to the local media storage 112 and/or when the local media storage 112 receives software or firmware updates.

The transport entertainment device 116 is a device configured to receive and display content on the entertainment platform 102. The transport entertainment device 116 is in communication with the onboard interface server 110. The transport entertainment device 116 may be integrated in the transport vessel and may have a hardwire connection to the onboard interface server 110. In an embodiment, the transport entertainment device 116 is a screen or display comprising a processor that is provided to one or more passengers on the transportation vessel.

The personal device 114 is any personal computing device that can communicate with the onboard interface server 110. The personal device 114 may include a smart phone, a tablet, a laptop, a personal computer, virtual or augmented reality device, and so forth. Personal devices 114 may communicate with the onboard interface server 110 by way of a local area network (LAN) connection or another network connection. In an embodiment, personal devices 114 can connection to a network 120, such as a cloud computing network or the Internet, by way of a network connection 118 that may be facilitated by the onboard interface server 110.

The entertainment server 122 may be located offsite at a location that is remote to the transportation vessel. The entertainment server 122 may be in communication with a network 120 such as a cloud computing network. In an embodiment, the onboard interface server 110 is in communication with the entertainment server 122 by way of the network 120 such that new programming may be uploaded from the entertainment server 122 to the onboard interface server 110.

The user database 124 is in communication with the entertainment server 122. The user database 124 stores information about user accounts that are associated with the entertainment platform 102. The user database 124 stores information about each user that has created an account with the entertainment platform 102. The user database 124 stores, for example, personal user information, user preferences, user advertising preferences, user reward history, user reward redemptions, user behavior when interacting with the entertainment platform, user travel history, user itinerary information, and so forth.

The media database 126 is in communication with the entertainment server 122. The media database 124 stores media data such as video files, music files, image files, text data, metadata, and so forth that is used by or associated with the entertainment platform 102. In an embodiment, new media is made available to the entertainment platform 102 from the media database 126 by way of the network 120 connection.

The network connection 118 provides the transportation vessel access to the network 120. The network 120 may include a cloud computing network, and/or the Internet, and/or part of a closed or private network. The network connection 118 may provide the onboard interface server 110 access to the network 120 and may further provide any of the transport entertainment devices 116 and/or personal devices 114 access to the network 120. The network connection 118 may be implemented differently depending on the type of transportation vessel. In an implementation where the transportation vessel is an airplane, the network connection 118 may connect to ground-based mobile broadband towers. The network connection 118 may include antennas attached to the airplane and the antennas of the network connection 118 may communicate with the one or more ground-based mobile broadband towers while the aircraft is in flight. In a further implementation, the network connection 118 uses satellite technology and the network connection 118 includes antennas on the aircraft configured to communicate with the nearest satellite signal. The network connection 118 may facilitate communication between any devices on the airplane, including the transport entertainment devices 116 and/or personal devices 114 and/or the onboard interface server 110 such that those devices may communicate with the network 120.

FIG. 2 is a block diagram of the entertainment platform 102. The entertainment platform 102 includes the media component 104, the rewards component 106, and the advertising component 108 as discussed in FIG. 1. The entertainment platform 102 may further include one or more of the user account component 202, the micro-site component 204, the reservation component 206, the interactive reward component 208, and the security component 210.

For purposes of illustration, programs and other executable program components are shown herein as discrete blocks, although it is understood that such programs and components may reside at various times in different storage components of a computing device and are executed by one or more processors. Alternatively, the systems and procedures described herein can be implemented in hardware, or a combination of hardware, software, and/or firmware. For example, one or more application specific integrated circuits (ASICs) can be programmed to carry out one or more of the systems and procedures described herein. As used herein, the term “component” is intended to convey the implementation apparatus for accomplishing a process, such as by hardware, or a combination of hardware, software, and/or firmware, for the purposes of performing all or parts of operations disclosed herein. The terms “component” is intended to convey independence in how the modules, components, or their functionality or hardware may be implemented in different embodiments.

The user account component 202 stores information pertaining to a user's account with the entertainment platform 102. The user account component 202 may prompt the user to enter personal information or to create an account with the entertainment platform 102. The user account component 202 may store information about how many rewards a user has accumulated and how the user has redeemed reward credits.

In an embodiment, a user creates a user account when engaging with the entertainment platform 102 and that user account information is stored on the user database 124 in communication with the entertainment server 122. The user may login to the user account by way of an Internet connection whether travelling or not. In an example, a user may login to the user account while waiting at an airport, continue to be logged in to the account while flying, may continue to be logged in to the account after landing, and so forth. The user may engage with the interactive information platform while travelling or when signed in to the user account by way of any Internet connection.

In an embodiment, a user may collect a maximum number of reward icons within the interactive information platform while on a single transportation journey. If the user does not collect the maximum number of reward icons available for that transportation journey, the user may continue to engage with the interactive information platform after the journey until the user finds the maximum number of reward icons. Such reward icons may be referred to as a “persistence.” In an embodiment, the user may continue to engage with the interactive information platform for a threshold duration of time until the opportunity to collect reward icons for the applicable journey is expired. In an embodiment, a user may begin to engage with the interactive information platform to find and collect reward icons even before the journey has begun. In an example, a user may login to a user account and begin to collect reward icons for an upcoming transportation journey before boarding for the journey. In such an embodiment, the user may find and collect the maximum number of reward icons for that flight, select a reward, and redeem the reward before boarding for the journey.

The micro-site component 204 stores information about an information page in the entertainment platform 102. In an embodiment, the entertainment platform 102 encompasses an interactive information platform. The interactive information platform provides guidance and information about various topics. In an example, the interactive information platform includes information about travel destinations, popular hotels or restaurants at those destinations, activities to do at certain destinations, and so forth. The information may be stored across “micro-sites” that are accessible by way of the onboard interface server 110.

In an embodiment, each hotel, restaurant, activity, and so forth has its own micro-site and the micro-site is funded by the corresponding business. For example, the entertainment platform 102 may include a micro-site for a popular hotel in New York City, and the corresponding hotel, or its affiliated marketing partner, may pay for that micro-site to be presented to passengers by way of the entertainment platform 102. In an embodiment, a passenger may book a room with the hotel directly through the entertainment platform 102. The transportation provider may receive ancillary revenue by selling micro-site pages to business or advertisers that wish to be featured in the entertainment platform 102.

The reservation component 206 enables a passenger to book a reservation on one of the micro-sites. In an embodiment, a passenger may book a reservation with a hotel, restaurant, car rental agency, and so forth directly through the entertainment platform 102 while traveling.

The interactive reward component 208 provides passengers the ability to earn rewards while engaging with the entertainment platform 102. The entertainment platform 102 encompasses an interactive information platform that enables users to discover and learn more about destinations, hotels, restaurants, activities, and so forth at their upcoming destination or at other destinations around the world. The interactive reward component 208 disperses interactive reward icons throughout the interactive information platform. A passenger receives a point or credit after tapping or clicking on an interactive reward icon. The interactive reward icon may be any suitable image, word, animation, and so forth.

The interactive reward component 208 determines how many interactive reward icons will be dispersed across the interactive information platform and further determines where the interactive reward icons will be displayed. In an embodiment, the number and placement of reward icons is adjusted in response to analytics as discussed further herein.

The security component 210 configures security settings and protocols for the entertainment platform 102. In an embodiment, a user may make an account with the entertainment platform 102 to save information to be recalled at a later time. The security component 210 ensures that a user's personal account information is kept secure and is encrypted where appropriate.

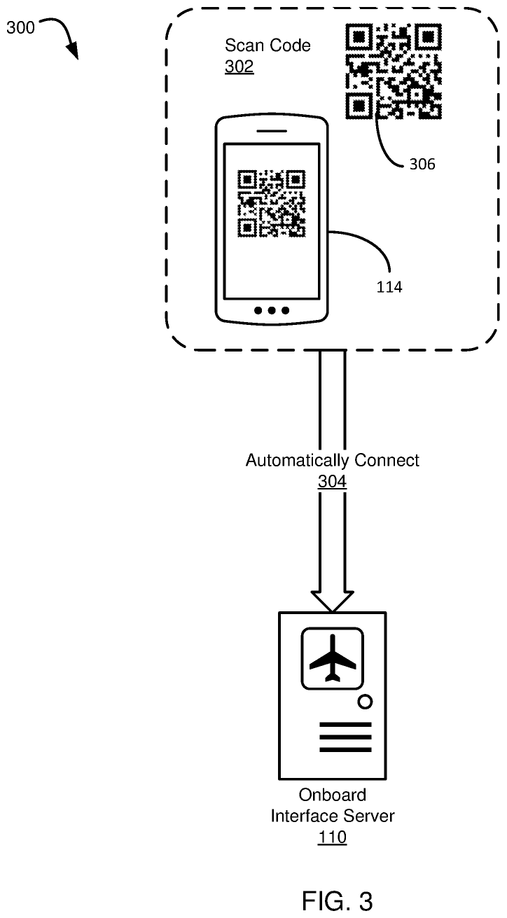

FIG. 3 is a schematic diagram of a system 300 for connecting a device to the onboard interface server 110. In an embodiment, a code 306 is provided and a personal device 114 can scan the code (see 302) to automatically connect (see 304) to the onboard interface server 110.

The code 306 may be any scannable figure or code that is readable by the personal device 114. In an embodiment, the code 306 is a two-dimensional barcode such as a quick response (QR) code. The two-dimensional barcode can be digitally scanned by a camera or other sensor on the personal device 114. In an embodiment, the code 306 is designed to appear like a graphic or image and the two-dimensional barcode is integrated or “hidden” in the image. The code 306 may include multiple squares that can be read by the image sensor of the personal device 114.

In an embodiment where the code 306 is a QR code, the code includes three large squares (the three large squares can be seen in the upper-left, lower-left, and upper-right corners of the example code 306 shown in FIG. 3) that serve as alignment targets while a smaller square in a remaining corner of the code 306 (the smaller square can be seen near the lower-right corner of the example code 306 shown in FIG. 3) serves to normalize the angle with which the image sensor hits the code 306. The remaining area of the code 306 is the actual data that is converted into binary code by the personal device 114. The code 306 may include many characters worth of data. In an example where the code 306 is a 117 pixel square, the code may hold 1852 characters of data.

In an embodiment, an image sensor of the personal device 114 is directed to scan the code 306, and the code 306 includes instructions for the personal device 114 to connect to the onboard interface server 110. A processor of the personal device 114 may execute the instructions stored in the code 306 to automatically connect 304 to the onboard interface server 110. In various implementations, the personal device 114 may request permission from a user and/or query the user whether the personal device 114 should connect to the onboard interface server 110. In an embodiment, automatically connecting 304 to the onboard interface server 110 includes deactivating an “airplane mode” on the personal device 114 such that the personal device can connect to a network 120 by way of onboard Wi-Fi or some other service. In an alternative embodiment, automatically connection 304 to the onboard interface server 110 includes enabling an airplane mode and/or ensuring that the airplane mode is activated before permitting the personal device 114 to connect to the onboard interface server 110. In an embodiment, automatically connecting 304 to the onboard interface server 110 brings the entertainment platform 102 up on the personal device 114 in an application, program, webpage, or by some other suitable means.

In an embodiment, the code 306 is a graphic image that can be scanned by an image sensor of the user's personal device and converted into binary instructions. The instructions cause the user's personal device to display an augmented reality three-dimensional image on a display of the personal device. The augmented reality three-dimensional image may appear to “come to life” and invite the user to connect to the onboard entertainment platform. This embodiment introduces a form of gamification to connecting to the onboard entertainment platform and encourages passengers to establish a connection with the onboard interface server 110.

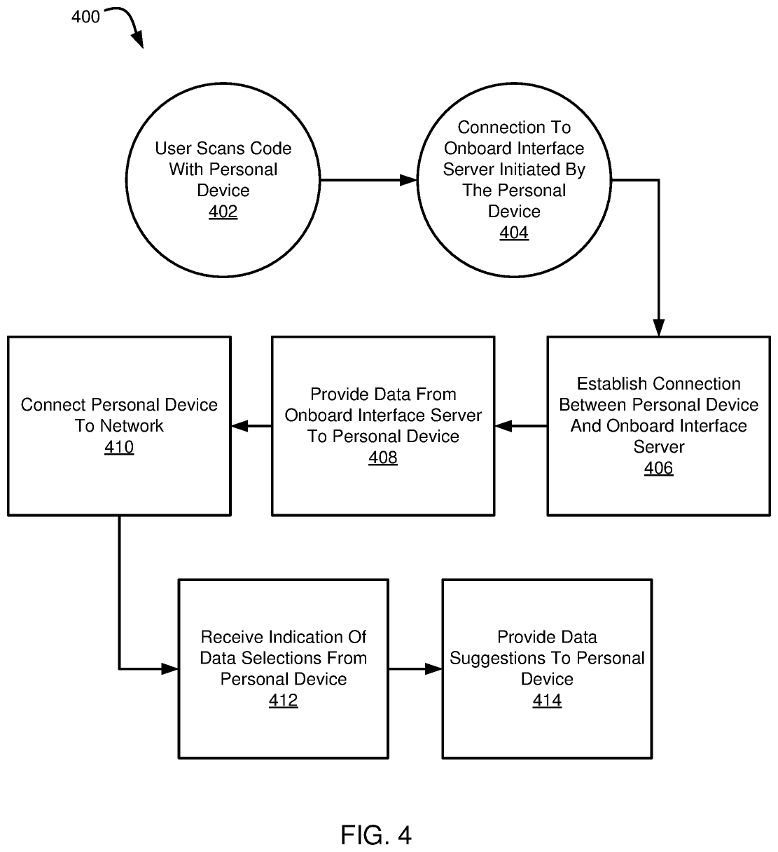

FIG. 4 is a schematic diagram of a process flow 400 for establishing a connection between a personal device and an onboard interface server. The process flow 400 begins and a user scans at 402 a code (see, e.g. 306) with a personal device 114. A connection to the onboard interface server 110 may be initiated at 404 by the personal device 114. The initiation of the connection to the onboard interface server 110 may require some user input. For example, the personal device 114 may require the user to deactivate an airplane mode on the personal device 114 or may require the user to agree to establish a connection with the onboard interface server 110. The onboard interface server 110 establishes a connection at 406 with the personal device 114. The onboard interface server 110 provides data at 408 to the personal device 114. The onboard interface server 110 facilitates a connection at 410 between the personal device 114 and the network 120, wherein the network 120 may be present on the transportation vessel by way of the network connection 118. The onboard interface server 110 receives at 412 a data selection or data input from the personal device 114. The onboard interface server 110 responds at 414 to the data selection or data input from the personal device 114.

The process flow 400 disclosed herein dramatically improves the speed with which a passenger can connect to the onboard interface server 110. This in turn increases the number of passengers that choose to connect to the onboard interface server 110 because the process is smooth and simplified. In an embodiment, a passenger must only hold a personal device 114 up to a code 306. The code 306 includes instructions for the personal device 114 to execute that causes the personal device 114 to automatically connect to onboard Wi-Fi and/or the onboard interface server 110 without significant or any intervention by the passenger.

The process flow 400 disclosed herein enables gamification of onboard entertainment systems. In an embodiment, a user may connect to the onboard interface server 110 by touching a three-dimensional image that initiates the gamification of the onboard entertainment system. In an embodiment, when the user touches the code 306, the code 306 causes the personal device 114 to connect to the onboard interface server 110 and the user is further provided with a notification that the user has found a first reward icon and the user may continue to locate reward icons to receive various rewards. The process flow 400 causes a passenger to be automatically connected to the onboard entertainment system without requiring the passenger to fill out lengthy or cumbersome surveys or inquiries for personal information. Additionally, the passenger is notified of how the rewards program works and is incentivized to continue looking for reward icons.

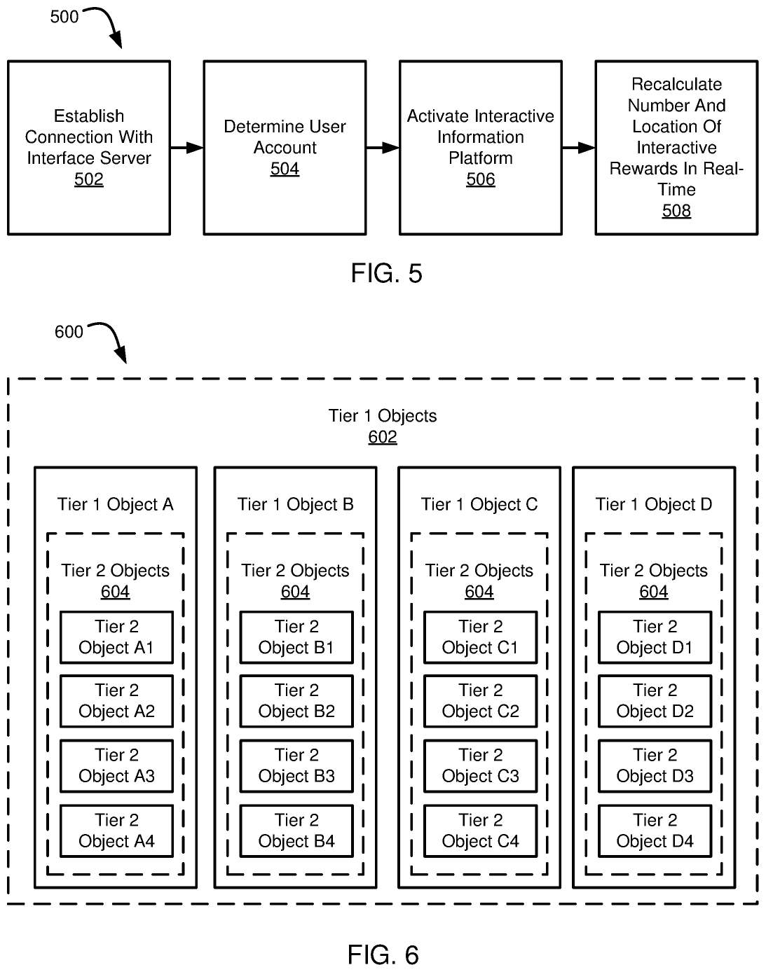

FIG. 5 is a block diagram of an example process flow 500 for operating an interactive information and advertising platform. A user may access the interactive information and advertising platform by way of a transport entertainment device 116 and/or a personal device 114. The transport entertainment device 116 and/or the personal device 114 may communicate with the interactive information and advertising platform by way of an onboard interface server 110.

The process flow 500 includes establishing at 602 a connection with the onboard interface server. The connection may exist between the onboard interface server and a transport entertainment device 116 and/or a personal device 114. The process flow 500 continues and a user account is determined at 504. Determining the user account may be accomplished based on, for example, a user's transportation ticket, a user logging in to the platform, a user signing up for the platform, an internet protocol (IP) address of the transport entertainment device 116 and/or the personal device 114, and so forth. The process flow 500 includes activating at 506 the interactive information platform. The process flow 500 includes recalculating at 508 a number and location of interactive rewards in real-time based on user information and user interaction with the interactive information platform.

information platform. The interactive information platform may be deployed by the onboard interface server and may be a component of the entertainment platform 102.

To provide context for the organizational structure 600, an example implementation of the interactive information platform, and the organizational structure 600 for objects within the interactive information platform, is described. In the example, the interactive information platform is deployed by an aircraft carrier. The aircraft carrier wishes to provide a reward program to incentivize passengers to engage with the interactive information platform. The interactive information platform is part of the in-flight entertainment system and is deployed by an onboard interface server 110 on each flight. Each airplane serviced by the aircraft carrier has its own onboard interface server 110 that deploys the in-flight entertainment system (i.e., the entertainment platform 102 and the interactive information platform) to transport entertainment devices 116 on seatbacks in the airplane and further to any compatible personal devices 114 brought on to the airplane by passengers. The aircraft carrier wishes to collect ancillary revenue from businesses that are featured on the interactive information platform. The aircraft carrier receives ancillary revenue based on how long users interact with the interactive information platform, which items users select in the interactive information platform, whether users purchase any items in the interactive information platform, and so forth. Therefore, the aircraft carrier wishes to incentive users to engage with the interactive information platform and to continue to engage with the interactive information platform for an extended period of time.

The reward program deployed by the aircraft carrier requires users to interact with the interactive information platform. In the reward program, a user may select different objects within the interactive information platform. Example objects may be example destinations that the aircraft carrier services, recommended restaurants in each destination, recommended hotels in each destination, and so forth. The aircraft carrier receives ancillary revenue by charging a fee to each hotel, restaurant, excursion, or other business that is featured on the interactive information platform. The aircraft carrier may further enable passengers to purchase goods or services through the interactive information platform, and the aircraft carrier may receive additional ancillary revenue when a passenger books a good or service through the interactive information platform.

In the reward program, a user aims to collect “interactive rewards” that are hidden throughout the interactive information platform. An interactive reward may be an animation or virtual sticker that is displayed on a screen. In the example implementation, the aircraft carrier displays a small animated logo somewhere on the screen of certain objects within the interactive information platform. When a user sees the animated logo, the user may tap or click on the animated logo to receive a credit. When the user collects enough credits, the user may qualify for various rewards. The rewards may be provided by the aircraft carrier and/or the businesses that are featured in the interactive information platform, or a 3^{rd} party. Example rewards could include a free beverage on a flight, a coupon for a restaurant at the user's destination, a flight credit, airline loyalty program rewards, a free night's stay at a hotel, and so forth.

The aircraft carrier wishes to balance two competing goals. The aircraft carrier wishes to maximize ancillary revenue by engaging users with the interactive information platform. Additionally, the aircraft carrier wishes to minimize the number of rewards provided to users. The aircraft carrier wishes to provide enough interactive rewards to incentivize users to engage with the interactive information platform but does not want to provide any more interactive rewards than necessary. The aircraft carrier balances these two competing goals by analyzing user interactions with the interactive information platform and adjusting user rewards in response to the analysis. In an embodiment, the number of interactive rewards and the locations of interactive rewards are adjusted in real-time on the flight. In an alternative embodiment, the number of interactive rewards and the locations of interactive rewards are adjusted and optimized by the entertainment server 122 and may be adjusted when the onboard interface server 110 is communicating with the network 120 or when the onboard interface server 110 is “offline.”

In an example, the aircraft carrier does not place interactive rewards on objects that are inherently popular and instead places interactive rewards on objects that selected less frequently. For example, the organizational structure 600 includes information about different travel destinations. Each of the tier 1 objects is a destination city, for example Beijing, Paris, and Cancun. In the example, Paris is the most popular, Beijing is the second most popular, and Cancun is viewed the least often out of the three cities. The aircraft carrier may choose to randomly place the interactive rewards on different pages but may weight the three cities such that Cancun is more likely to have an interactive reward. Because Paris is the most popular city, this may encourage passengers to view information about less popular cities. Additionally, this may prevent the aircraft carrier from paying reward credits when passengers view information they might have already viewed absent the reward program.

In an example, each “object” in the organizational structure 600 is an information page that may be accessed by way of a transport entertainment device 116 and/or a personal device 114. Each of the information pages may be stored locally on the local media storage 112 and/or the media database 126. Each information page may be provided to a device by the onboard interface server 110, and the onboard interface server 110 may further respond to interactions from a user e.g. by providing a certain page in response to the user selecting that page.

The organizational structure 600 includes tier 1 objects 602 and tier 2 objects 604. In an example, the tier 1 objects include destination cities and the tier 2 objects include hotels, restaurants, activities, and so forth for a certain destination city. In the example illustrated in FIG. 6, there exist four tier 1 objects 602, including tier 1 object A, tier 1 object B, tier 1 object C, and tier 1 object D. Tier 2 objects 604 exist within one or more of the tier 1 objects. In the example shown in FIG. 6, there exists four tier 2 objects 604 within each of the tier 1 objects 602. It should be appreciated there may be any number of tier 1 objects 602 and/or tier 2 objects 604, and each of the tier 1 objects 602 may have the same or different number of tier 2 objects 604. In the example illustrated in FIG. 6, tier 1 object A includes four tier 2 objects, including tier 2 object A1, tier 2 object A2, tier 2 object A3, and tier 2 object A4. Further, tier 1 object B includes four tier 2 objects, including tier 2 object B1, tier 2 object B2, tier 2 object B3, and tier 2 object B4. Further, tier 1 object C includes four tier 2 objects, including tier 2 object C1, tier 2 object C2, tier 2 object C3, and tier 2 object C4. Further, tier 1 object D includes four tier 2 objects, including tier 2 object D1, tier 2 object D2, tier 2 object D3, and tier 2 object D4.

The interactive information platform may include multiple tier 1 objects 602 and each of the multiple tier 1 objects may be ranked against one another based on estimated popularity, actual real-time popularity, popularity with a certain user account, advertising revenue rate, and so forth. Additionally, each of the multiple tier 2 objects for a certain tier 1 object may be ranked against one another based on estimated popularity, actual real-time popularity, popularity with a certain user account, advertising revenue rate, and so forth. The organizational structure 600 may include further tiers and each of the further tiers may be ranked against one another on one or more of the same bases. Additionally, objects across different tiers may further be ranked against one another on one or more of the same bases. For example, tier 2 object C2 may be determined to be more popular than the entirety of tier 1 object B, and so forth.

The rankings of the objects in the organizational structure 600 may be used to determine how many interactive rewards to place throughout the interactive information platform and where to place those interactive rewards. The rankings may be adjusted in real-time in response to what objects are being selected. Additionally, the rankings of the objects in the organizational structure 500 may be used to determine sponsorship value, advertising value, and/or rates for advertising costs. The analysis for which objects are being selected may apply to all user accounts worldwide across multiple transportation industries and carriers and/or all user accounts for a selection of transportation industries or a selection of carriers and/or all user accounts on a certain vessel at one time and/or a history or current activity for a certain user account. The analysis may consider all of the above groupings of user accounts and each grouping may be weighted differently. Each object in the organization structure 600 may receive a score based on the analysis, and this score may impact whether that object has an interactive reward.

In an embodiment, an object has a higher ranking, i.e. is more likely to have an interactive reward, if that object is less popular among a group of users. In an embodiment, a notification may be provided to a user to suggest to the user where interactive rewards are more likely to be hidden. For example, a notification may provide a clue that suggests the user is more likely to find interactive rewards in a certain city or under a certain category such as hotels or activities.

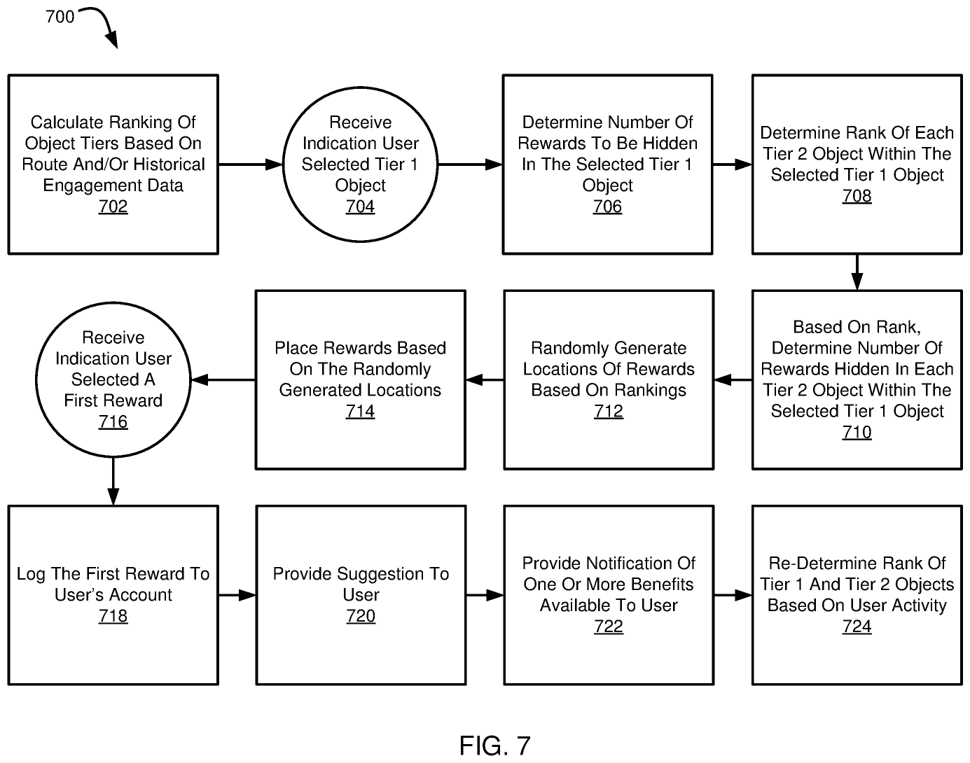

FIG. 7 is a schematic diagram of a process flow 700 for ranking objects in an interactive information platform. The process flow 700 begins and a computing device calculates at 702 rankings for object tiers and/or individual objects based on a transportation route and/or based on historical engagement data. The historical engagement data may indicate that a certain object is popular or unpopular with users. The transportation route data may indicate that a certain information page should be displayed on a certain route. For example, if the transportation vessel is a cruise ship travelling from a city in Florida to a city in Mexico, the interactive information platform may provide information on cities in Mexico and/or Florida. The process flow 700 continues and the onboard interface server 110 receives at 704 an indication that a user has selected a tier 1 object. In an example, a tier 1 object is a destination city. The process flow 700 continues and a computing device determines at 706 a number of rewards to be hidden in the selected tier 1 object. The computing device determines at 708 a rank for each tier 2 object within the selected tier 1 object. The computing device determines at 710, based on rank, a number of rewards to be hidden in each tier 2 object within the selected tier 1 object. The computing device randomly generates at 712 locations of rewards based at least in part on the ranking. The computing device places rewards at 714 based on the randomly generated locations. The onboard interface server 110 receives at 716 an indication that a user has selected a first reward. The user may select a reward by tapping or clicking the reward while it is displayed on an information page. In an embodiment, a reward is displayed only temporarily on a page and the user may tap or click on the reward before the reward disappears.

The process flow 700 continues and a computing device logs the first reward to the user's account at 718. The computing device provides a suggestion to the user at 720, such as a suggestion of a related object to view or a suggestion of where other rewards may be found. The computing device provides a notification at 722 of one or more benefits available to the user based on the user finding the reward. The computing device re-determines at 724 a rank of tier 1 and tier 2 objects based on the user's activity.

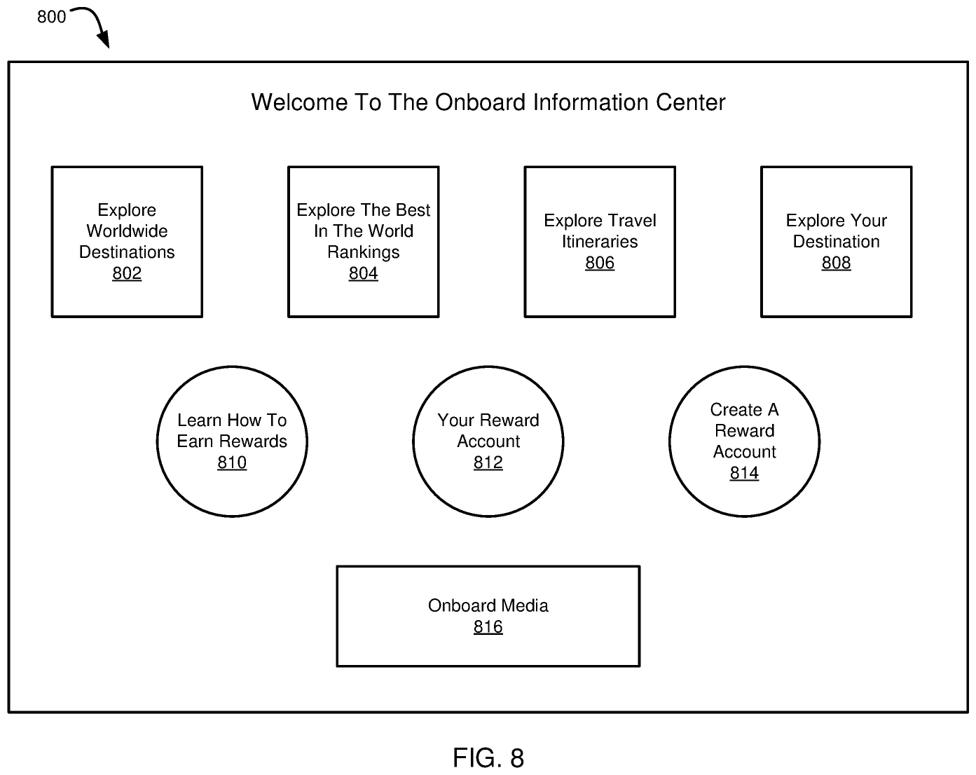

FIG. 8 is a screenshot of an example homepage 800 of an onboard information center. The homepage 800 includes multiple buttons that may be selected by a user. Example buttons includes options to explore worldwide destinations 802, explore the best in the world rankings 804, explore travel itineraries 806, and explore the user's destination 808. Additional example buttons include options for a user to learn how to earn rewards 810, access the user's reward account 812, and create a new reward account 814. Additionally, the user may access onboard media 816 such as movies, television shows, games, and other programs.

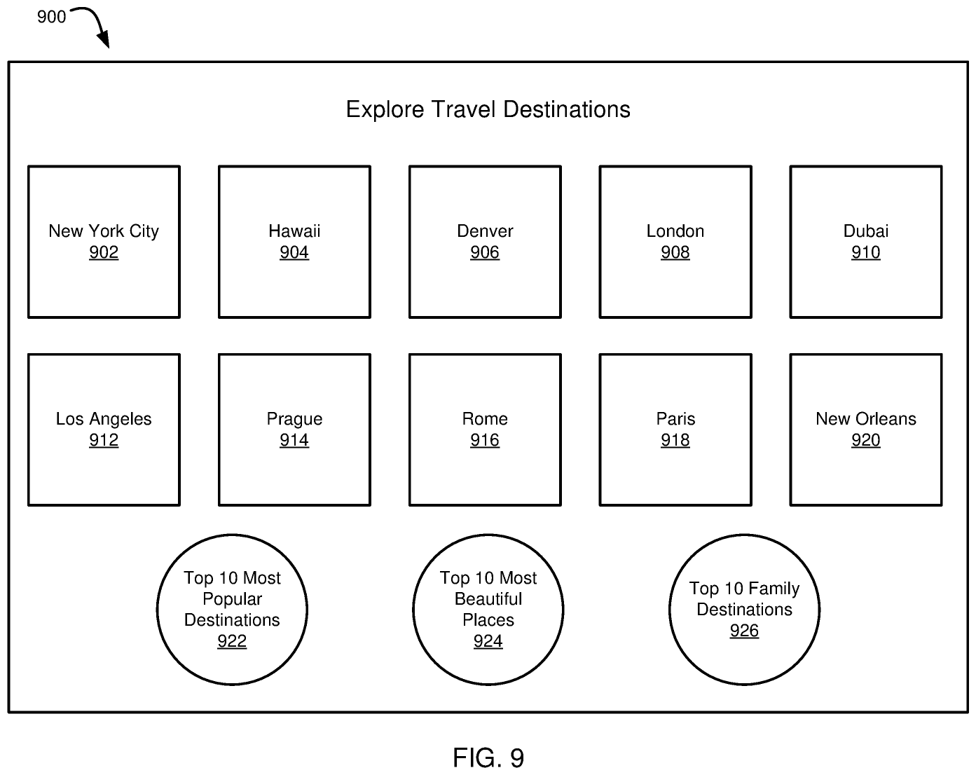

FIG. 9 is a screenshot of an example tier 1 object selection page 900. In the example, the page 900 gives the user options to explore different destination cities. Example destinations shown in the screenshot include New York City 902, Hawaii 904, Denver 906, London 908, Dubai 910, Los Angeles 912, Prague 914, Rome 916, Paris 918, and New Orleans 920. Additionally, a user may select to view “best of” listings such as the top 10 most popular destinations 922, the top 10 most beautiful places 924, and the top 10 family destinations 926. In the example, each of the possible destinations is considered a tier 1 object.

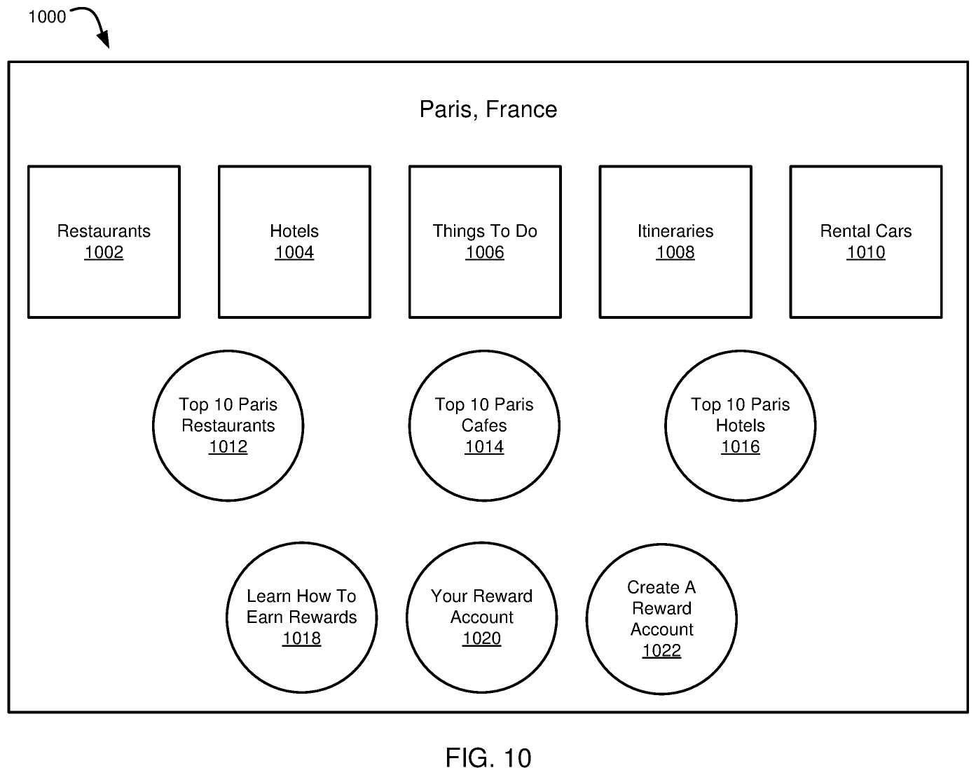

FIG. 10 is a screenshot of an example tier 1 object page 1000. In the example, the page 1000 is a destination city and specifically Paris, France. When on the page 1000, a user has the option to select a tier 2 object that is about Paris, France. For example, a user may select restaurants 1002, hotels 1004, things to do 1006, itineraries 1008, and/or rental cars 1010. Each of the options applies to Paris, France when on the Paris, France page 1000. Additionally, a user may View Top 10 Paris Restaurants 1012, Top 10 Paris Cafes 1014, and Top 10 Paris Hotels. Additionally, a user may access information about their own account, including learning how to earn rewards 1018, accessing their own reward account 1020, and/or creating a reward account 1022.

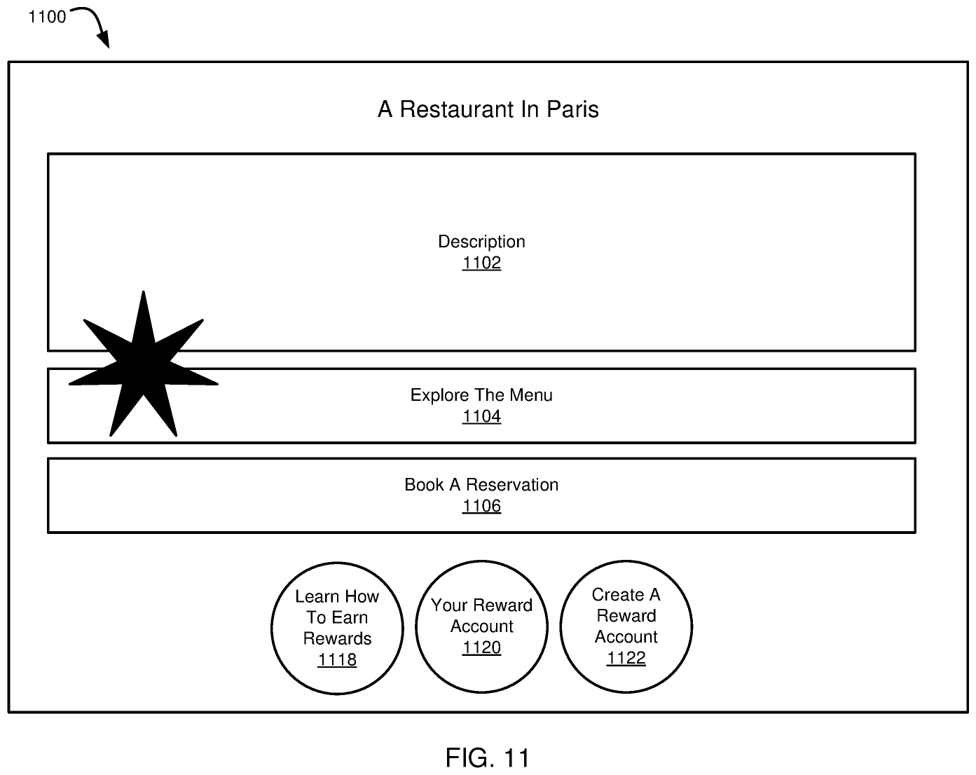

FIG. 11 is an example screenshot of an information page 1100. The information page 1100 may be considered a tier 3 object, wherein the applicable tier 1 object would be the Paris, France destination, the tier 2 object would be the listing of restaurants in Paris, and the tier 3 object is the information page 1100 for a specific restaurant. On the information page 1100, a user may read a description 1102 about the applicable restaurant. The description 1102 may include text, video, or images about the applicable restaurant. Additionally, a user may explore the menu 1104 of the restaurant and/or book a reservation 1106 at the restaurant. The user also has quick access to learning how to earn rewards 1118, accessing the user's reward account 1120, and creating a reward account 1122. The information page 1100 shown in FIG. 11 includes an interactive reward 1108 icon. A user may tap or click on the interactive reward 1108 to receive a credit for engaging with the interactive information platform.

The interactive reward 1108 icon may be any suitable image, animation, text, or other symbol to include phonics as well. In an embodiment, the interactive reward 1108 icon is the logo of the airline or a logo of the provider of the interactive information platform. The interactive reward 1108 icon may be displayed on a page for a set amount of time and then disappear. In an embodiment, if the user does not tap on the interactive reward 1108 before it disappears, the user will not receive the reward credit.

In an embodiment, a passenger may view different pages of the interactive information platform in search of multiple reward icons and may qualify for a unique award redemption page after finding a threshold number of reward icons. The award redemption page may be built into the interactive information platform and made accessible to the user by way of the onboard interactive server 110.

In an embodiment, the transportation provider may control which rewards are provided to passengers for finding certain reward icons or for finding a threshold number of reward icons. In an embodiment, certain reward icons may be displayed on object pages that are rarely selected or viewed, and those certain reward icons may qualify the passenger for a unique reward. The transportation provider may elect to provide different tiers of rewards to passengers with different class fares. In an embodiment, a passenger may upgrade a transportation ticket to become eligible for a higher reward tier. In an embodiment, a passenger may become eligible for a higher reward tier after traveling a threshold number of miles and/or spending a threshold amount of money with the transportation provider.

In an embodiment, a reward redemption page is provided to a passenger that finds a threshold number of reward icons while viewing different object pages in the interactive information platform. The available rewards may be provided on the reward redemption page. In an embodiment, the passenger may review the available rewards and make a selection. The passenger may spend reward credits immediately to purchase a reward or the passenger may elect to save reward credits. The passenger may save the reward credits to an account that is stored on the user database 124 in communication with the onboard interface server 110. When the passenger travels again, the passenger may log into the account and continue to find reward icons that will be applied as additional reward points to the account. The passenger may continue to collect reward points over numerous travels and then use the reward points to purchase higher tier rewards. In an embodiment, rewards can be collected across transportation partners, such as across multiple airline partners in the aviation industry.

In an embodiment, a finite number of each reward is available across all users. In such an embodiment, after a user selects and purchases a reward from the reward redemption page, that reward is removed such that other passenger can no longer see the reward. In a case where, for example, there are 500 available rewards of a certain type, the system will permit only 500 users to claim that certain reward.

In an embodiment, after a user has collected a sufficient number of reward icons to redeem a reward, the user may redeem a reward immediately while on the transportation vessel or may elect to redeem or receive the reward at a later time. The user may be given a code or password to enter the reward redemption page to access the page from the transportation vessel at a later time, on a different transportation vessel and/or different journey, while at home or at an airport, and so forth. In an embodiment, the reward redemption page is a live and active option that encourages passengers to take part in the platform from any location.

In an embodiment, after a passenger spends reward points to purchase a reward, a code or coupon for the reward may be sent to the passenger's account. The passenger may access the code or coupon by way of a cloud computing network and/or the Internet. In an embodiment, each transportation trip has a defined number of available rewards to be claimed by passengers on that trip. After the defined number of available rewards have been claimed, those rewards cannot be claimed by other passengers.

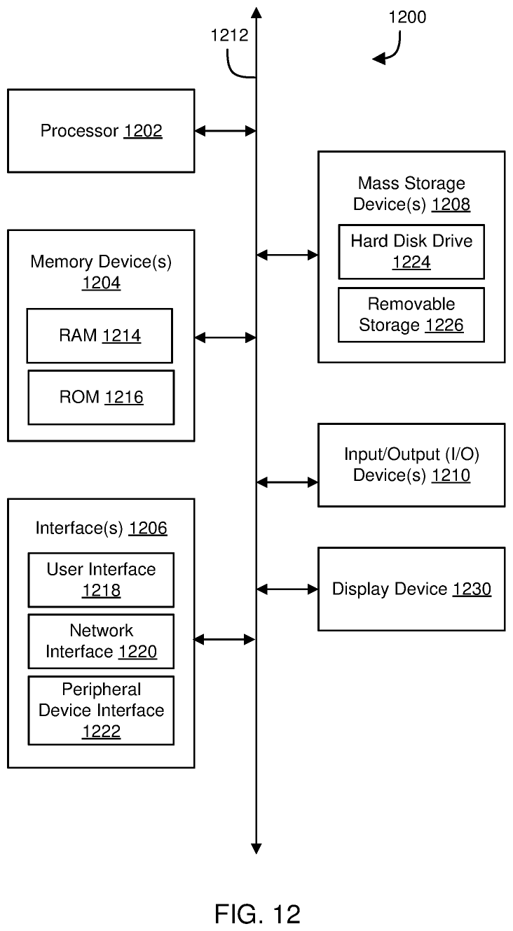

Referring now to FIG. 12, a block diagram of an example computing device 1200 is illustrated. Computing device 1200 may be used to perform various procedures, such as those discussed herein. Computing device 1200 can perform various monitoring functions as discussed herein, and can execute one or more application programs, such as the application programs or functionality described herein. Computing device 1200 can be any of a wide variety of computing devices, such as a desktop computer, in-dash computer, vehicle control system, a notebook computer, a server computer, a handheld computer, tablet computer and the like.

Computing device 1200 includes one or more processor(s) 1202, one or more memory device(s) 1204, one or more interface(s) 1206, one or more mass storage device(s) 1208, one or more Input/output (I/O) device(s) 1210, and a display device 1230 all of which are coupled to a bus 1212. Processor(s) 1202 include one or more processors or controllers that execute instructions stored in memory device(s) 1204 and/or mass storage device(s) 1208. Processor(s) 1202 may also include various types of computer-readable media, such as cache memory.

Memory device(s) 1204 include various computer-readable media, such as volatile memory (e.g., random access memory (RAM) 1214) and/or nonvolatile memory (e.g., read-only memory (ROM) 1216). Memory device(s) 1204 may also include rewritable ROM, such as Flash memory.

Mass storage device(s) 1208 include various computer readable media, such as magnetic tapes, magnetic disks, optical disks, solid-state memory (e.g., Flash memory), and so forth. As shown in FIG. 12, a particular mass storage device 1208 is a hard disk drive 1224. Various drives may also be included in mass storage device(s) 1208 to enable reading from and/or writing to the various computer readable media. Mass storage device(s) 1208 include removable media 1226 and/or non-removable media.

I/O device(s) 1210 include various devices that allow data and/or other information to be input to or retrieved from computing device 1200. Example I/O device(s) 1210 include cursor control devices, keyboards, keypads, microphones, monitors, touchscreen devices, or other display devices, speakers, printers, network interface cards, modems, and the like.

Display device 1230 includes any type of device capable of displaying information to one or more users of computing device 1200. Examples of display device 1230 include a monitor, display terminal, video projection device, and the like.

Interface(s) 1206 include various interfaces that allow computing device 1200 to interact with other systems, devices, or computing environments. Example interface(s) 1206 may include any number of different network interfaces 1220, such as interfaces to local area networks (LANs), wide area networks (WANs), wireless networks, and the Internet. Other interface(s) include user interface 1218 and peripheral device interface 1222. The interface(s) 1206 may also include one or more user interface elements 1218. The interface(s) 1206 may also include one or more peripheral interfaces such as interfaces for printers, pointing devices (mice, track pad, or any suitable user interface now known to those of ordinary skill in the field, or later discovered), keyboards, and the like.

Bus 1212 allows processor(s) 1202, memory device(s) 1204, interface(s) 1206, mass storage device(s) 1208, and I/O device(s) 1210 to communicate with one another, as well as other devices or components coupled to bus 1212. Bus 1212 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 1800 and are executed by processor(s) 1802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein. As used herein, the terms “module” or “component” are intended to convey the implementation apparatus for accomplishing a process, such as by hardware, or a combination of hardware, software, and/or firmware, for the purposes of performing all or parts of operations disclosed herein. The terms “module” or “component” are intended to convey independent in how the modules, components, or their functionality or hardware may be implemented in different embodiments.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural, functional, object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components or modules, which are terms used to more particularly emphasize their implementation independence. For example, a component or module may be implemented as a hardware circuit comprising custom very large-scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over different locations including over different storage devices, and may exist, at least partially, merely as electronic signals on a system or network. The components may be passive or active, including agents operable to perform desired functions.

### EXAMPLES

The following examples pertain to further embodiments.

Example 1 is a method. The method includes determining a travel destination for a user and determining historical engagement data for the user engaging with an interactive entertainment platform. The method includes ranking a plurality of object categories within the interactive entertainment platform based on the current travel destination and the historical engagement data. The method includes receiving an indication that the user has selected an object category within the interactive entertainment platform.

Example 2 is a method as in Example 1, wherein the travel destination for the user is a current travel destination when a user is on board a common carrier en-route to the travel destination or a planned future travel destination for the user.

Example 3 is a method as in any of Examples 1-2, wherein a user interface for the interactive entertainment platform is provided to an electronic device made accessible to the user, wherein the electronic device is one or more of a personal electronic device or an onboard transport entertainment device.

Example 4 is a method as in any of Examples 1-3, further comprising providing a stream of audiovisual content to the interactive entertainment platform made accessible to the user.

Example 5 is a method as in any of Examples 1-4, further comprising calculating a number of rewards to be presented to the user within the interactive entertainment platform based on the travel destination and the historical engagement data.

Example 6 is a method as in any of Examples 1-5, further comprising randomly generating locations for displaying a plurality of rewards on a plurality of user interface screens within the interactive entertainment platform, wherein each of the plurality of user interface screens are made accessible to the user for finding the rewards.

Example 7 is a method as in any of Examples 1-6, further comprising receiving an indication that the user has selected a reward of the plurality of rewards.

Example 8 is a method as in any of Examples 1-7, further comprising, in response to the user selecting the reward, applying a value of the reward to an account associated with the user.

Example 9 is a method as in any of Examples 1-8, further comprising: associating an account within the interactive entertainment platform with the user; tracking reward points claimed by the account when the user has interacted with the interactive entertainment platform; and offering reward benefits for sale to the user, wherein the reward benefits can be purchased by the user with reward points.

Example 10 is a method as in any of Examples 1-9, further comprising providing the user access to the interactive entertainment platform when the user is on board a common carrier.

Example 11 is non-transitory computer readable storage media storing instructions for execution by one or more processors, wherein the instructions comprise any of the method steps in Examples 1-10.

Example 12 is a system comprising one or more processors configurable to execute instructions stored in non-transitory computer readable storage media, wherein the instructions comprising any of the method steps in Examples 1-10.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure.

What is claimed is:

1. A method comprising:
determining a travel destination for a user;
determining historical engagement data for the user engaging with an interactive entertainment platform;
ranking a plurality of object categories within the interactive entertainment platform based on the current travel destination and the historical engagement data; and
receiving an indication that the user has selected an object category within the interactive entertainment platform.

2. The method of claim 1, wherein the travel destination for the user is a current travel destination when a user is on board a common carrier en-route to the travel destination or a planned future travel destination for the user.

3. The method of claim 1, wherein a user interface for the interactive entertainment platform is provided to an electronic device made accessible to the user, wherein the electronic device is one or more of a personal electronic device or an onboard transport entertainment device.

4. The method of claim 1, further comprising providing a stream of audiovisual content to the interactive entertainment platform made accessible to the user.

5. The method of claim 1, further comprising calculating a number of rewards to be presented to the user within the interactive entertainment platform based on the travel destination and the historical engagement data.

6. The method of claim 1, further comprising randomly generating locations for displaying a plurality of rewards on a plurality of user interface screens within the interactive entertainment platform, wherein each of the plurality of user interface screens are made accessible to the user for finding the rewards.

7. The method of claim 6, further comprising receiving an indication that the user has selected a reward of the plurality of rewards.

8. The method of claim 7, further comprising, in response to the user selecting the reward, applying a value of the reward to an account associated with the user.

9. The method of claim 1, further comprising:
associating an account within the interactive entertainment platform with the user;
tracking reward points claimed by the account when the user has interacted with the interactive entertainment platform; and
offering reward benefits for sale to the user, wherein the reward benefits can be purchased by the user with reward points.

10. The method of claim 1, further comprising providing the user access to the interactive entertainment platform when the user is on board a common carrier.

11. Non-transitory computer readable storage media storing instructions for execution by one or more processors, the instructions comprising:
determining a travel destination for a user;
determining historical engagement data for the user engaging with an interactive entertainment platform;
ranking a plurality of object categories within the interactive entertainment platform based on the current travel destination and the historical engagement data; and
receiving an indication that the user has selected an object category within the interactive entertainment platform.

12. The non-transitory computer readable storage media of claim 11, wherein the travel destination for the user is a current travel destination when a user is on board a common carrier en-route to the travel destination or a planned future travel destination for the user.

13. The non-transitory computer readable storage media of claim 11, wherein a user interface for the interactive entertainment platform is provided to an electronic device made accessible to the user, wherein the electronic device is one or more of a personal electronic device or an onboard transport entertainment device.

14. The non-transitory computer readable storage media of claim 11, wherein the instructions further comprise providing a stream of audiovisual content to the interactive entertainment platform made accessible to the user.

15. The non-transitory computer readable storage media of claim 11, wherein the instructions further comprise calculating a number of rewards to be presented to the user within the interactive entertainment platform based on the travel destination and the historical engagement data.

16. A system comprising one or more processors configurable for executing instructions stored in non-transitory computer readable storage media, the instructions comprising:
determining a travel destination for a user;
determining historical engagement data for the user engaging with an interactive entertainment platform;
ranking a plurality of object categories within the interactive entertainment platform based on the current travel destination and the historical engagement data; and
receiving an indication that the user has selected an object category within the interactive entertainment platform.

17. The system of claim 16, wherein the instructions further comprise randomly generating locations for displaying a plurality of rewards on a plurality of user interface screens within the interactive entertainment platform, wherein each of the plurality of user interface screens are made accessible to the user for finding the rewards.

18. The system of claim 17, wherein the instructions further comprise receiving an indication that the user has selected a reward of the plurality of rewards.

19. The system of claim 18, wherein the instructions further comprise, in response to the user selecting the reward, applying a value of the reward to an account associated with the user.

20. The system of claim 16, wherein the instructions further comprise:
associating an account within the interactive entertainment platform with the user;
tracking reward points claimed by the account when the user has interacted with the interactive entertainment platform; and
offering reward benefits for sale to the user, wherein the reward benefits can be purchased by the user with reward points.
